(19) United States
(12) Patent Application Publication
(10) Pub. No.: US 2008/0176551 A1
(43) Pub. Date: Jul. 24, 2008

(54) Mobile terminal and method of receiving radio waveform at the same

(75) Inventor: Hideyuki Kawabata, Tokyo (JP)

Correspondence Address: JUNICHI MIMURA;OKI AMERICA INC., 1101 14TH STREET, N.W., SUITE 555, WASHINGTON, DC, 20005, US

(73) Assignee: Oki Electric Industry Co., Ltd.

(21) Appl. No.: 12/000,386

(22) Filed: Dec. 12, 2007

(30) Foreign Application Priority Data
Jan. 19, 2007 (JP) 2007-010384

(51) Int. Cl. H04Q 7/20

(52) U.S. Cl. 455/421

(57) ABSTRACT

A mobile terminal for judging by receiving a radio waveform sent from a particular base station whether or not the mobile terminal is located in a service area provided by the base station includes a signal receiver searching the base station by receiving the radio waveform from the base station, a processing unit setting an interval in response to the search result performed by the signal receiver, a request signal for searching the base station compulsory and a condition showing the period for being located out of the service area, and transiting the condition to another condition, and a control unit controlling the signal receiver to start searching the base station at the interval set by the processing unit.

### CROSS-REFERENCE TO RELATED APPLICATION

This application claims the priority benefit of Japanese Patent Application No. 2007-010384, filed Jan. 19, 2007, the entire disclosure of which is incorporated herein by reference.

### BACKGROUND OF THE INVENTION

1. Field of the Invention

The invention relates to a mobile terminal, such as a cellular phone terminal, and a method of receiving a radio waveform at the mobile terminal, specifically relates to a power saving mobile terminal, which judges whether or not the terminal is located in the service area of a base station by receiving a radio waveform from the base station, and a method of receiving a radio waveform at the mobile terminal.

2. Description of the Related Art

Recent years, when a mobile terminal, such as a cellular phone terminal, is located out of the service area of its base station, it is required to save the power of the cellular phone terminal in accordance with the usage conditions by adjusting intervals of receiving a signal without causing the user of the cellular phone terminal to set parameters of the intervals for receiving the radio waveform.

In the Japanese reference JP 2000-174689A, a conventional cellular phone terminal, which saves the power of its battery, and the method of its system are disclosed. In such a system, when a cellular phone terminal is located out of the service area of its base station, the cellular phone terminal detects signal strengths of radio waveforms as to the control information sent from the base station periodically, analyzes the signal strengths in chronological order, predicts the strength of the radio waveform of the next time by the linear prediction analysis, and sets the parameters of the intervals of receiving the radio waveform. The cellular phone terminal measures the signal strengths as to the control information at the intervals set by itself, and determines another interval for the next search, based on the measurement of the signal strength. By repeating the above-described operation, it is possible to save the power during the stand-by operation.

However, according to the conventional system described above, it takes a time to change the usage condition from the outside of the service area (no service state) to the inside of the service area (in service state). Further, it is required to calculate the complex linear prediction analysis in the conventional system so that the size of the cellular phone terminal becomes larger, and the power consumption also becomes larger for the arithmetic processes of the linear prediction analysis.

### SUMMARY OF THE INVENTION

An objective of the invention is to solve the above-described problem and to provide a mobile terminal having a low power consumption characteristic.

The objective is achieved by a mobile terminal for judging by receiving a radio waveform sent from a particular base station whether or not the mobile terminal is located in a service area provided by the base station, which includes a signal receiver searching the base station by receiving the radio waveform from the base station, a processing unit setting an interval in response to the search result performed by the signal receiver, a request signal for searching the base station compulsory and a condition showing the period for being located out of the service area, and transiting the condition to another condition, and a control unit controlling the signal receiver to start searching the base station at the interval set by the processing unit.

### BRIEF DESCRIPTION OF THE DRAWINGS

The invention will be more particularly described with reference to the accompanying drawings, in which:

FIG. 1 is a block diagram of a cellular phone terminal, according to the first embodiment;

FIG. 2 is a flow chart showing an operation of the cellular phone terminal of FIG. 1; and

FIG. 3 is a conceptual diagram showing four conditions of the cellular phone terminal.

### DETAILED DESCRIPTION OF THE PREFERRED EMBODIMENTS

The preferred embodiment of the invention is explained together with drawings as follows. In each drawing, the same reference numbers designate the same or similar components.

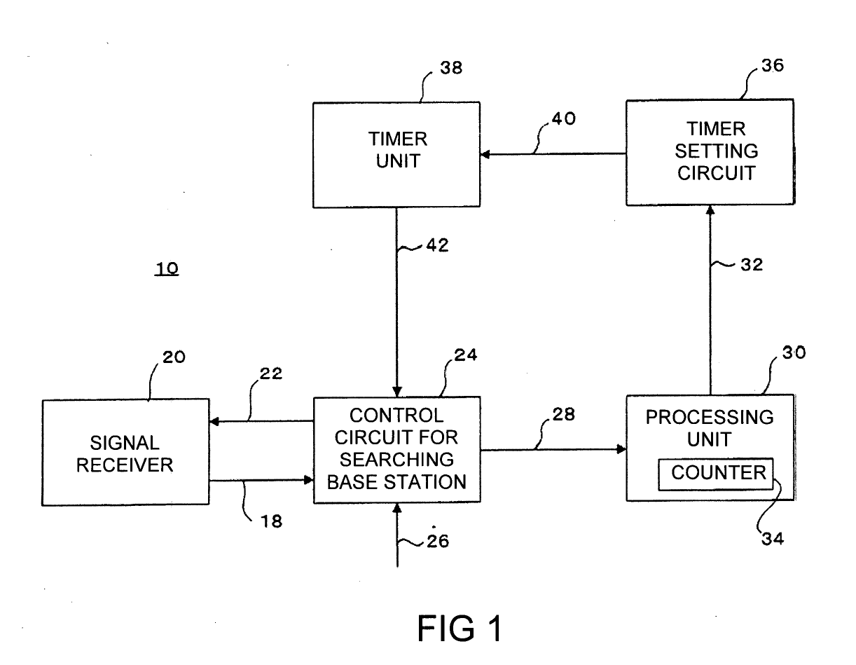

FIG. 1 is a block diagram of a mobile terminal 10, such as a cellular phone terminal. The cellular phone terminal 10 includes a signal receiver 20, a control circuit 24 for searching an unillustrated base station by receiving a radio wave form, a processing unit 30, a timer setting circuit 36 and a timer unit 38. The signal receiver 20 receives a radio waveform sent from the base station, determines whether or not the cellular phone terminal 10 is located in the service area of the base station, and generates a signal showing a search result of the base station. Then, the signal receiver 20 outputs a receiving signal 18 including the aforementioned search result as to the base station on a connection line. The control circuit 24 is connected to the signal receiver 20 by the connection line, and receives a receiving signal 18 from the signal receiver 20. The control circuit 24 is also connected to the signal receiver 20 by another connection line, and sends on the connection line a first instruction signal 22, which includes an instruction to the signal receiver 20 for receiving a radio waveform. When a user requests to receive a radio waveform manually (it is called “compulsory search”), a request signal 26 is inputted through a connection line, and is inputted to the control circuit 24. When the control circuit 24 receives such the request signal 26, then it instructs the signal receiver 20 to do so by sending the first instruction signal 22. Further, the control circuit 24 sends a condition signal 28 including information of the receiving signal 18 sent from the signal receiver 20 and information whether or not the request signal 26 is inputted, to the processing unit 30. The request signal 26 is made by the user or by presetting the cellular phone terminal 10 through its menu function.

The processing unit 30, which outputs an interval setting signal 32 for setting a new interval of receiving a radio waveform in response to the condition signal 28 including the information of the receiving signal 18 and the information whether or not the request signal 26 is inputted, to a timer setting circuit. The processing unit 30 includes a counter 34, which counts the number of times that the control circuit 24 continuously detects the cellular phone terminal 10 being located out of the service area.

In response to the interval setting signal 32 from the processing unit 30, the timer setting circuit 36 sets the new interval, and sends a second instruction signal 40 including the renewed information as to the interval in order to receiving a radio waveform at the intervals to the timer unit 38. The timer unit 38 measures the time corresponding to the interval, which indicates the radio waveform receiving condition that the cellular phone terminal 10 is located out of the service area. The timer unit 38 notifies the control circuit 24 by a timing signal 42 when the time is up.

In response to the timing signal 42, the control circuit 24 sends the first instruction signal 22, which includes the instruction to the signal receiver 20 for receiving a radio waveform. In response to the first instruction signal, the signal receiver 20 starts a new search for detecting signal strength of a radio waveform sent from a particular base station, and notifies the result of the detection through the receiving signal 18 to the control circuit 24.

As described above, the control circuit 24 sends the condition signal 28 including information of the receiving signal 18 including the result of the detection and information whether or not the request signal 26 is inputted, to the processing unit 30. When the signal receiver 20 finds a valid base station by detecting the radio waveform, the counter 34 in the processing unit 30 is reset in response to the condition signal 28 having such information. Under the condition, the information whether or not the request signal 26 is inputted may not be sent to the processing unit 30.

When the signal receiver 20 fails to find the valid base station, the counter 34 in the processing unit 30 increases its number by one. In accordance with the increase of the counter 34, a new interval setting signal 32 for setting a longer interval is outputted to the timer setting circuit 36. Namely, based on the radio waveform receiving conditions showing whether or not the cellular phone terminal 10 is located in the service area, the processing unit 30 controls the timer units by the new interval setting signal 32 and transits its radio waveform receiving condition.

The interval is set by the following steps. Initially, the aggregate of the intervals is called THE AGGREGATE “T”. Here, the aggregate T is defined as follows.

T={T_{—}0, T_{—}1, . . . T_{—}a}(0<T_{—}0<T_{—}1< . . . <T_{—}a)

Here, when the signal receiver 20 receives a radio waveform showing the cellular phone terminal 10 is located out of the service area for the first time, it is defined that the cellular phone terminal 10 is in the condition “Condition_{—}1”. If the signal receiver 20 continuously receives a radio waveform showing the cellular phone terminal 10 is located out of the service area, it is defined that the cellular phone terminal 10 is in the condition “Condition_{—}2”. Thus, when the decisions that the cellular phone terminal 10, which is in the “Condition_s”, is located out of the service area are continuously made for “N_s” times, the interval is set at “T_s” by the processing unit 30, and the condition is transited to “Condition_s+1”. The aggregate of the number of times of the continuous decision that the cellular phone terminal 10 is located out of the service area is called THE AGGREGATE “N”. Here, the aggregate N is defined as follows.

N={N_{—}0, N_{—}1, . . . N_a}

When the decision that the cellular phone terminal 10 is located in the service area, then the cellular phone terminal 10 performs the stand-by operation and its condition is transited to “Condition_{—}0”.

When the interval is set at long because the cellular phone terminal 10 is continuously located out of the service area for long time, it takes a time to perform the operation for receiving a radio waveform even if the cellular phone terminal 10 moves within the service area actually. This means that the cellular phone terminal 10 displays “no service” for a while even if it is in the service area. Thus, if the user thinks the cellular phone terminal 10 is located in the service area, the operation for searching a base station can be performed compulsory by a manual operation. Such a compulsory searching operation is performed by the request signal 26. Under the compulsory searching operation by the request signal 26, when the cellular phone terminal 10-finds a particular base station, then it performs the stand-by operation and its condition is transited to “Condition_{—}0”. Although the compulsory searching operation can be made for pushing a certain button specialized for its purpose, it is not limited. Another operation such as placing a call to the cellular phone terminal 10 may be recognized as the compulsory searching operation.

When the cellular phone terminal 10 decides that it is located out of the service area as a result of the compulsory searching operation, a particular interval is applied. Generally, the demand of the user for using the cellular phone terminal 10 increases under the situation that the compulsory searching operation is performed. Thus, in consideration of the demand, the interval is shortened. For example, if the condition of the cellular phone terminal 10 is in the condition “Condition_s” at the time of the demand, the condition is transited to “Condition_s-u” wherein “u” is a variable number, and the interval is set at “T_(s-u-1)”. The threshold number of times of the continuous decision that the cellular phone terminal 10 is located out of the service area becomes “N_(s-u)”.

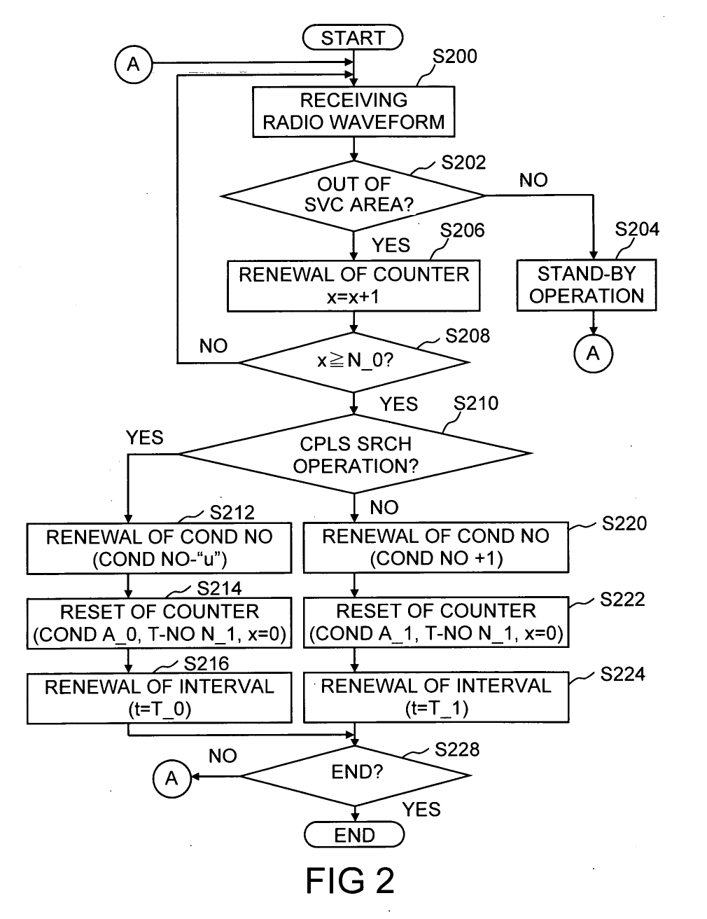

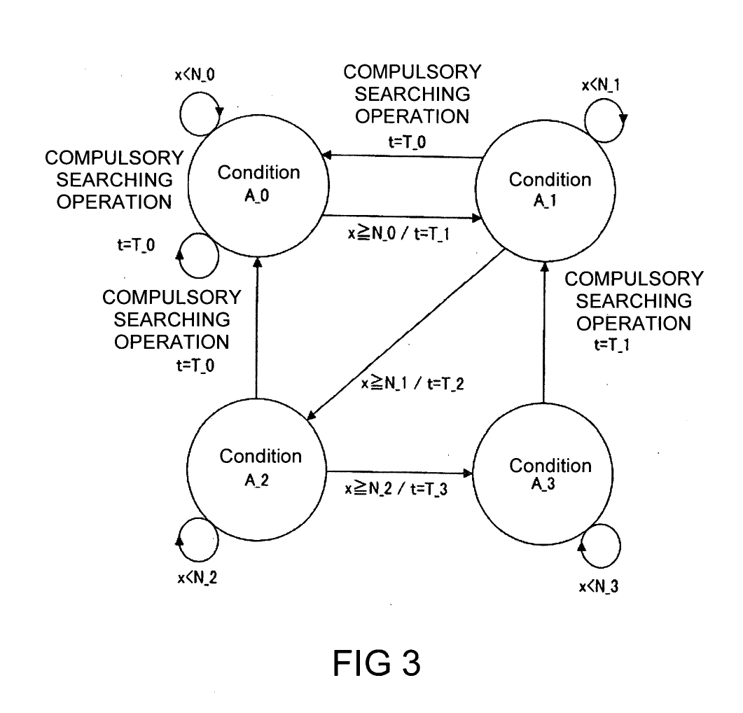

Next, the operation of the cellular phone terminal 10 is explained as follows with reference to FIG. 2 and FIG. 3. FIG. 2 is a flow chart showing an operation of the cellular phone terminal of FIG. 1, and FIG. 3 is a conceptual diagram showing four conditions of the cellular phone terminal.

Initially, the cellular phone terminal 10 is set for receiving a radio waveform at a certain interval. This condition is illustrated in FIG. 3 as “Condition A_{—}0” with “N_{—}0”. In the step S200, by sending the first instruction signal 22 to the signal receiver 20 at the interval, the signal receiver 20 is activated, and starts receiving the radio waveform.

In the step S202. The control circuit 24 confirms whether or not the signal receiver 20 receives the radio waveform by analyzing a receiving signal 18. The control circuit 24 judges by the receiving signal 22 that the cellular phone terminal 10 is in the service area, and then the stand-by operation is performed for a particular period in accordance with the Step S204. After the stand-by operation is terminated, then operation in the Step S200 is performed again.

When the control circuit 24 judges by the receiving signal 22 that the cellular phone terminal 10 is out of the service area in the Step S202, the number “x” in the counter 34 is renewed by increasing by one in the Step S206.

In the Step S208, it is judged whether the renewed number “x” is larger than the predetermined threshold number, which is set in accordance with the each condition. Thus, if the renewed number “x” is equal to or larger than the predetermined threshold number (“x”>“N_{—}0”), then the Step S210 is performed next. If the renewed number “x” is less than the predetermined threshold number (“x”<“N_{—}0”), the step S200 is repeated (“Condition A_{—}0”).

In the Step S210, it is judged whether or not the compulsory searching operation is performed. If the result is positive, then the Step S212 is performed.

In the Step S212, the condition number is renewed by subtracting a number “u” from the current condition number (Condition A_“condition number-u”). The number “u” can be set at an appropriate integral number. When the number “u” is larger than the current condition number, the condition number is renewed to zero (0), and the zero becomes the renewed condition number.

In the Step S214, the threshold number is renewed to a new number, which corresponds to the renewed condition number, and the counter 34 is reset (“Condition A_{—}0”, Threshold number N_1, x=0). Then, in the Step S216, the current interval is renew to a new interval, which corresponds to the renewed condition, and the timer unit 38 is set at the renewed interval (t=T_0).

In the Step S210, if the result is negative, which means that no compulsory searching operation is instructed, then the Step S220 is performed. In the Step S220, the condition number is renewed by increasing by one to the current condition number (Condition A_“condition number+1”).

In the Step 222, the threshold number is renewed to a new number, which corresponds to the renewed condition number, and the counter 34 is reset (“Condition A_{—}1”, Threshold number N_1, x=0). Then, in the Step S224, the current interval is renew to a new interval, which corresponds to the renewed condition, and the timer unit 38 is set at the renewed interval (t=T_1).

The explanation described above is the operation of the transition from the initial condition “Condition A_{—}0” to the renewed condition “Condition A_{—}1”. In FIG. 3, four conditions, for instance, of the cellular phone terminal 10 is illustrated. The condition of the cellular phone terminal 10 is transited among the four conditions (“Condition A_{—}0”˜“Condition A_{—}3”) in this embodiment. In FIG. 3, the condition “Condition A_n” is illustrated as “Condition” and “A_n” in two lines, the interval “T_n” means the interval belonging to the aggregate “T” at the condition “Condition A_n”, and the number “N_n” means the number belonging to the aggregate “N” at the condition “Condition A_n”. The “t” means the interval, and the “x” means the number indicated by the counter 34.

As shown in FIG. 3, the cellular phone terminal 10 under the “Condition A_{—}0” maintains its condition under the state of (“x”≦“N_{—}0”), and transits its condition to “Condition A_{—}1” under the state of (“x”>“N_{—}0”/t=T_{—}1). The cellular phone terminal 10 under the “Condition A_{—}1” maintains its condition under the state of (“x”<“N_{—}1”), and transits its condition to “Condition A_{—}2” under the state of (“x”≧“N_{—}1”/t=T_{—}2). If the compulsory searching operation is performed under this condition, then the condition of the cellular phone terminal 10 retunes to “Condition A_{—}0” at the interval “t=T_{—}0”.

Moreover, the cellular phone terminal 10 under the “Condition A_{—}2” maintains its condition under the state of (“x”<“N_{—}2”), and transits its condition to “Condition A_{—}3” under the state of (“x”≧“N_{—}2”/t=T_{—}3). If the compulsory searching operation is performed under this condition, then the condition of the cellular phone terminal 10 retunes to “Condition A_{—}0” at the interval “t=T_{—}0”. The cellular phone terminal 10 under the “Condition A_{—}3” maintains its condition under the state of (“x”<“N_{—}3”), and transits its condition to “Condition A_{—}1” at the interval “t=T_{—}1” if the compulsory searching operation is performed.

As explained above, when the compulsory searching operation is performed, the condition is transited to the “Condition A_m−2”. If the “m” is less than 2, the condition is transited to the “Condition A_{—}0”. According to this transition rule, the appropriate interval is set. In other words, the relatively short interval was set at time of the the compulsory searching operation, the new interval is set at short, and the relatively long interval was set at time of the compulsory searching operation, the new interval is set at a little longer.

According to the cellular phone terminal of the preferred embodiment of the invention, the varied intervals can be set in response to the radio waveform receiving condition of the cellular phone terminal 10. Thus, it is possible to reduce the amount of the power consumption. Further, no complex calculation for setting the interval is required. Moreover, since the compulsory searching operation can be performed, when the cellular phone terminal 10 is moved from the outside of the service area to the inside of the service area, the cellular phone terminal 10 can detects the radio waveform without waiting for the next operation of the search starting after the interval.

While the invention has been described with reference to illustrative embodiments, this description is not intended to be construed in a limiting sense. Thus, shapes, size and physical relationship of each component are roughly illustrated so the scope of the invention should not be construed to be limited to them. Further, to clarify the components of the invention, hatching is partially omitted in the cross-sectional views. Moreover, the numerical description in the embodiment described above is one of the preferred examples in the preferred embodiment so that the scope of the invention should not be construed to limit to them.

For example, although the preferred embodiment is explained with the cellular phone terminal 10, it is not limited for it. The invention can be applied to any kinds of the mobile terminal, which detects the wireless waveform, such as a PHS (Personal Handy phone System), a Wireless LAN (local area network), or a BlackBerry™.

Various other modifications of the illustrated embodiment will be apparent to those skilled in the art on reference to this description. Therefore, the appended claims are intended to cover any such modifications or embodiments as fall within the true scope of the invention.

What I claim is:

1. A mobile terminal for judging by receiving a radio waveform sent from a particular base station whether or not the mobile terminal is located in a service area provided by the base station, comprising:
a signal receiver searching the base station by receiving the radio waveform from the base station;
a processing unit setting an interval in response to the search result performed by the signal receiver, a request signal for searching the base station compulsory and a condition showing the period for being located out of the service area, and transiting the condition to another condition; and
a control unit controlling the signal receiver to start searching the base station at the interval set by the processing unit.

2. A mobile terminal as claimed in claim 1, wherein the processing unit includes a counter, which counts a number of the search result showing that the mobile terminal is located out of the service area, and wherein the processing unit determines the interval for searching the base station in response to the number of the counter.

3. A mobile terminal as claimed in claim 2, wherein the counter is reset when processing unit recognized that the mobile terminal is located in the service area or when the compulsory search is performed by the request signal.

4. A mobile terminal for judging by receiving a radio waveform sent from a particular base station whether or not the mobile terminal is located in a service area provided by the base station, comprising:
a first function for searching the base station by receiving the radio waveform from the base station;
a second function for performing a stand-by operation receiving the radio waveform continuously when the result of the first function indicates that the mobile terminal is located in a service area, and for increasing by one in a counter, which indicate the number of the search result showing that the mobile terminal is located out of the service area, when the result of the first function indicates that the mobile terminal is located out of the service area,
a third function for searching the base station compulsory;
a fourth function for placing the mobile terminal to the first condition in which the first function is performed at a first interval in response to the result of the third function indicating that the mobile terminal is located out of the service area; and
a fifth function for placing the mobile terminal to the second condition in which the first function is performed at a second interval in response to the state that the mobile terminal is located out of the service area without performing the fourth function.

5. A mobile terminal as claimed in claim 4, wherein the first interval is shorter than the second interval.

6. A mobile terminal as claimed in claim 4, wherein the first and the second intervals are determined by the number of the search result showing that the mobile terminal is located out of the service area.
